(19) United States
(12) Patent Application Publication
(10) Pub. No.: US 2012/0078660 A1
(43) Pub. Date: Mar. 29, 2012

(54) WEB-BASED TOOL TO PREPARE FOR AND SELECT AN ELECTRONIC HEALTH RECORD SYSTEM

(75) Inventors: Joseph Mangicaro, Fayetteville, NY (US); Timothy Callahan, Skaneateles, NY (US); Bruce Kleaveland, Seattle, WA (US)

(73) Assignee: WELCH ALLYN, INC., Skaneateles Falls, NY (US)

(21) Appl. No.: 12/891,837

(22) Filed: Sep. 28, 2010

(51) Int. Cl. G06Q 50/00; G06Q 10/00

(52) U.S. Cl. 705/3

(57) ABSTRACT

A web-based tool is provided that helps a healthcare provider to prepare for a transition to an EHR system and to select an EHR system that is appropriate for the healthcare provider's practice. A server provides questionnaire webpages to the healthcare provider. The questionnaire webpages include questionnaires to be completed by the healthcare provider. The server receives responses to the questionnaires. The server can generate an EHR transition plan based on the responses. In addition, the server can generate a request for proposal (RFP). The RFP contains a description of an appropriate EHR system. The server generates the description of the appropriate EHR system based on the responses. The RFP also contains a request by the healthcare provider for a proposal to provide the appropriate EHR system to the healthcare provider. The server then sends the RFP to vendors selected by the healthcare provider.

### BACKGROUND

Conventionally, healthcare providers keep paper health records for each of their patients. A patient's health record can include a variety of information, such as the patient's health history, a list of the patient's allergies, information about the health of the patient's family, and other information relevant to the patient's health. There are several drawbacks to paper health records. For example, paper health records are difficult to share among healthcare providers, require large amounts of storage space, are not electronically searchable, are easily lost or stolen, and so on.

More recently, healthcare providers have started to transition from paper health records to electronic health records. Electronic health records contain information similar to paper health records, but are stored in electronic form. Because electronic health records are stored in electronic form, the electronic health records can be easier to share among healthcare providers, can require less storage space, and can be electronically searchable. As healthcare providers have started to transition to electronic health records, many vendors have started offering electronic health record (EHR) systems. EHR systems are computerized systems for using electronic health records.

Despite the advantages of electronic health records, some healthcare providers have been reluctant to transition from paper health records to electronic health records. At least some of this reluctance is due to uncertainty about how to select an appropriate EHR system. Healthcare providers typically do not have the time, resources, or expertise to systematically investigate and evaluate available EHR systems on their own. On the other hand, many healthcare providers do not want to spend the money needed to hire consultants to select EHR systems for them.

### SUMMARY

A web-based tool is provided that helps healthcare providers select EHR systems that are appropriate for their practices. A server provides questionnaire webpages to a healthcare provider. The questionnaire webpages include questionnaires to be completed by the healthcare provider. The server receives responses to the questionnaires. The server generates a request for proposal (RFP) based at least in part on the responses. The RFP contains a description of an appropriate EHR system. The server generates the description of the appropriate EHR system based on the responses to the questionnaires. The RFP also contains a request by the healthcare provider for a proposal to provide the appropriate EHR system to the healthcare provider. The server then sends the RFP to vendors selected by the healthcare provider.

### BRIEF DESCRIPTION OF THE DRAWINGS

FIG. 1 is a block diagram illustrating an example system for helping a healthcare provider to select an EHR system that is appropriate for the healthcare provider's practice.

FIG. 2 is a block diagram illustrating example details of a server.

FIG. 3 is a flowchart illustrating an example operation performed by the server.

FIG. 4 illustrates an example hierarchy of webpages hosted by the server.

FIG. 5 illustrates an example hierarchy of webpages within a set of technology and workflow planning webpages.

FIG. 6 illustrates an example cover letter generated by the server.

FIG. 7 is a block diagram illustrating an example computing system.

### DETAILED DESCRIPTION

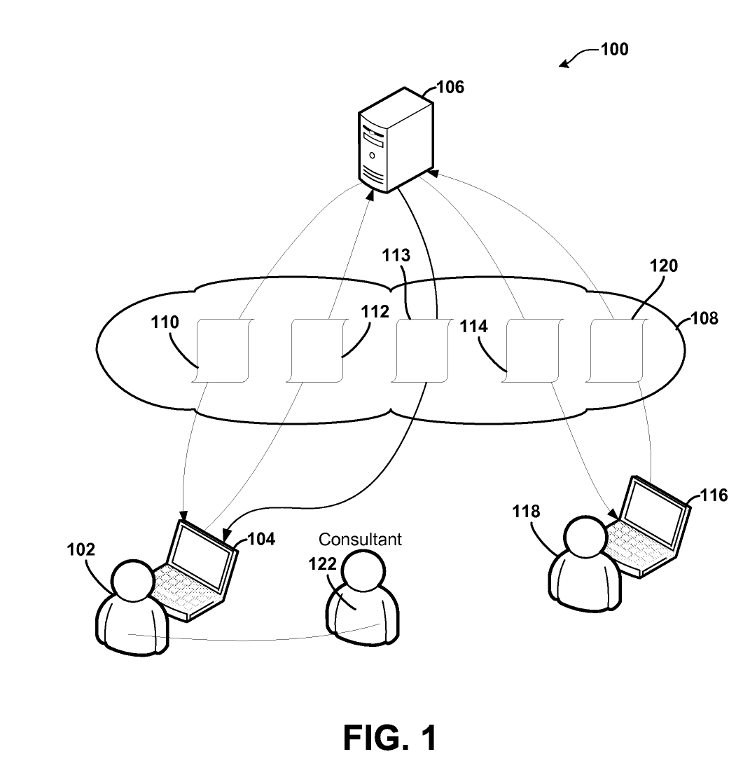

FIG. 1 is a block diagram illustrating an example system 100 for helping a healthcare provider 102 to prepare for and select an EHR system that is appropriate for the healthcare provider's practice. As illustrated in the example of FIG. 1, the system 100 comprises a client device 104, a server 106, and a network 108.

The healthcare provider 102 is a person or entity that provides human or animal healthcare services. For example, the healthcare provider 102 can be an individual physician, a doctors' office, a hospital, a clinic, a veterinarians' office, or another type of person or entity that provides healthcare services. The healthcare provider 102 or a representative of the healthcare provider 102 uses the client device 104. The client device 104 can be a variety of different types of computing devices. For example, the client device 104 can be a personal computer, a laptop computer, a netbook computer, a handheld computer, a tablet computer, or another type of computing device.

The server 106 provides an EHR preparation and selection service that helps the healthcare provider 102 to prepare for a transition to an EHR system and to select an appropriate EHR system. As part of providing the EHR preparation and selection service, the server 106 provides webpages to the healthcare provider 102. To provide the webpages to the healthcare provider 102, the server 106 sends webpage data 110 to the client device 104 via the network 108. The client device 104 processes the webpage data 110 to present the webpages to the healthcare provider 102.

The webpages provided by the server 106 include preparation webpages. Some of the preparation webpages include assignments for the healthcare provider 102 to complete. For example, one of the preparation webpages can prompt the healthcare provider 102 to select people to participate on an EHR transition committee. Furthermore, some of the preparation webpages include questionnaires to be completed by the healthcare provider 102. In various embodiments, the questionnaires include various questions. For example, the questionnaires can include questions about how the healthcare provider 102 intends to use an EHR system in workflows performed by the healthcare provider 102. In another example, the questionnaires can include questions about how much the healthcare provider 102 thinks the EHR system will help productivity.

The server 106 receives responses to the questionnaires. To receive the responses to the questionnaires, the server 106 receives response data 112 sent by the client device 104. The response data 112 represents the responses of the healthcare provider 102 to the questionnaires. After the server 106 receives the responses to the questionnaires, the server 106 generates an EHR transition plan 113. The EHR transition plan 113 is a document that summarizes a plan to transition to an EHR system. The EHR transition plan 113 can include information such as the readiness of the healthcare provider 102 to adopt the EHR system, how the healthcare provider 102 intends to use the EHR system in the workflows performed by the healthcare provider 102, and how the healthcare provider 102 intends to implement the EHR system. The EHR transition plan 113 can also provide guidance on how to conduct a formal vendor evaluation and selection process. After the server 106 generates the EHR transition plan 113, the server 102 sends the EHR transition plan 113 to the client 104. The healthcare provider 102 can use the EHR transition plan 113 during a process of selecting an appropriate EHR system, preparing the healthcare provider's practice to use the EHR system, and implementing the EHR system at the healthcare provider's practice.

Furthermore, after the server 106 receives the responses to the questionnaires, the server 106 generates a request for proposal (RFP) 114. The RFP 114 is a set of one or more documents that state a request for a proposal for providing an appropriate EHR system to the healthcare provider 102. The RFP 114 contains a description of the appropriate EHR system. The server 106 generates the description of the appropriate EHR system based on the responses given by the healthcare provider 102 to the questionnaires.

After generating the RFP 114, the server 106 sends the RFP 114 to a client device 116 used by a vendor 118. The server 106 enables the healthcare provider 102 to select the vendor 118 from among a plurality of vendors. After the client device 116 receives the RFP 114, the vendor 118 reviews the RFP 114 and prepares a proposal 120. The server 106 receives the proposal 120 from the client device 116 via the network 108. The proposal 120 describes how the vendor 118 proposes to provide the EHR system to the healthcare provider 102. After the server 106 receives the proposal 120, the server 106 forwards the proposal 120 to the client device 104. The healthcare provider 102 then reviews the proposal 120.

In the example of FIG. 1, the system 100 also includes a consultant 122. The consultant 122 is a person with expertise in the EHR system industry. The healthcare provider 102 can consult with the consultant 122 during the process of selecting an appropriate EHR system. In some embodiments, the healthcare provider 102 purchases the right to use the EHR preparation and selection service provided by the server 106. In some embodiments, consultation time with the consultant 122 is bundled with the purchase of the right to use the EHR preparation and selection service. In various embodiments, the healthcare provider 102 communicates with the consultant 122 in various ways. For example, the healthcare provider 102 can communicate with the consultant 122 directly. In other embodiments, the healthcare provider 102 communicates with the consultant 122 through the server 106.

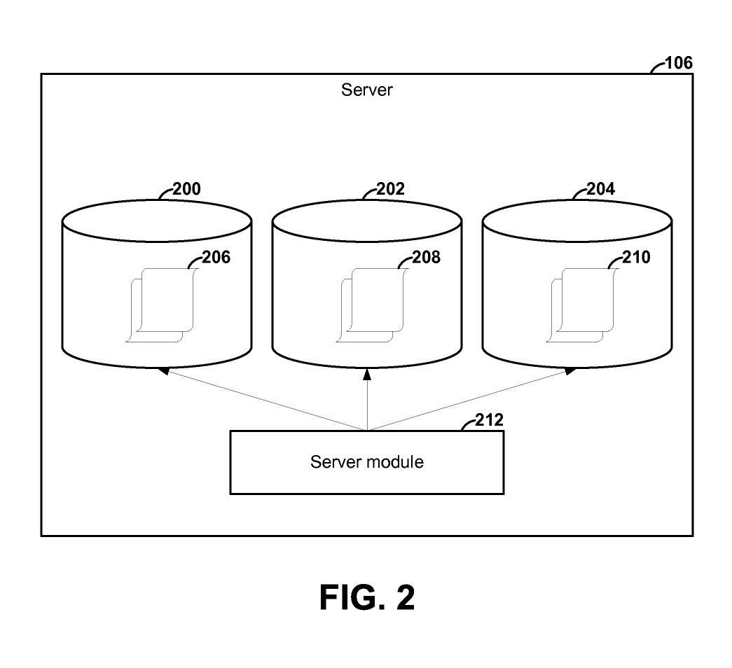

FIG. 2 is a block diagram illustrating example details of the server 106. In various embodiments, the server 106 is implemented in various ways. For example, the server 106 can be implemented as one or more computing devices. Example types of suitable computing devices include standalone server devices, blade servers, personal computers, mainframe computers, and other types of computing devices.

As illustrated in the example of FIG. 2, the server 106 comprises a webpage database 200, a response database 202, and a proposal database 204. The webpage database 200 stores webpage data 206, such as the webpage data 110. The webpage data 206 represents webpages provided by the server 106. The response database 202 stores responses 208 to questionnaires provided to healthcare providers, such as the responses 112 provided by the healthcare provider 102. The proposal database 204 stores proposals 210 received from vendors, such as the proposal 120 sent by the vendor 118.

The webpage database 200, the response database 202, and the proposal database 204 can be implemented in various ways. For example, the webpage database 200, the response database 202, and the proposal database 204 can be implemented as relational databases, text or binary files, or other systems of storing data for later retrieval. Although the webpage database 200, the response database 202, and the proposal database 204 are illustrated as separate databases in the example of FIG. 2, some embodiments implement the webpage database 200, the response database 202, and/or the proposal database 204 together as a single database.

Furthermore, the server 106 comprises a server module 212. The server module 212 is a software application that processes resource requests received by the server 106 via the network 108. For example, the server module 212 receives requests to retrieve webpages hosted by the server 106 and sends webpage data representing the requested webpages. Furthermore, the server module 212 receives and processes requests to post or put data received from the network 108 to the server 106. In various embodiments, the server module 212 can be various types of available web server applications, such as the MICROSOFT® Internet Information Services (IIS) server, the Apache web server, the nginx web server, the lighttpd web server, or another available web server application.

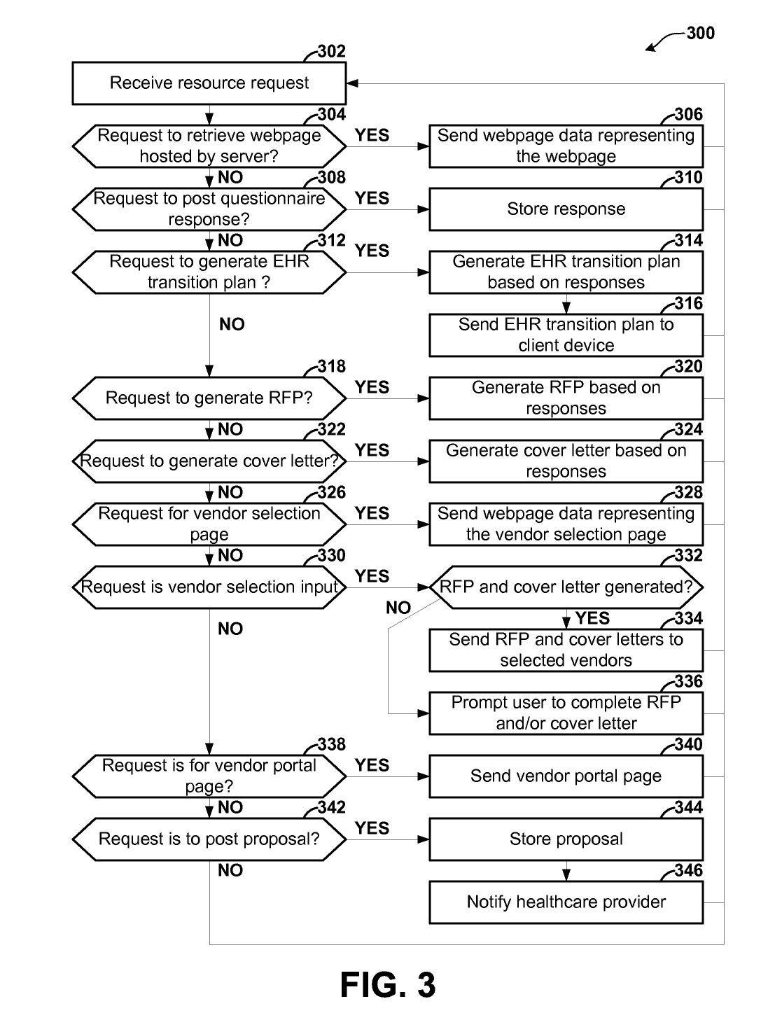

FIG. 3 is a flowchart illustrating an example operation 300 performed by the server 106. As illustrated in the example of FIG. 3, the operation 300 begins when the server 106 receives a resource request via the network 108 (302). In various embodiments, the resource request is formatted in various ways. For example, the resource request can be formatted as a Hypertext Transfer Protocol (HTTP) request, a SOAP request, a remote procedure call request, a file transfer protocol (FTP) request, or a request formatted according to another communications protocol.

In response to receiving the resource request, the server module 212 determines whether the resource request is a request to retrieve a webpage hosted by the server 106 (304). For example, the server 212 can determine whether the resource request is a request to retrieve one of the preparation webpages. If the resource request is a request to retrieve a webpage hosted by the server 106 (“YES” of 304), the server module 212 sends corresponding webpage data to a client device that sent the resource request (306). The corresponding webpage data represents the requested webpage. The server module 212 can then perform the operation 300 with regard to another resource request. In various instances and embodiments, the server module 212 performs various actions to send the corresponding webpage data. For example, the server module 212 can retrieve the corresponding webpage data from the webpage database 200. In another example, the server module 212 can dynamically generate the corresponding webpage data using data into the webpage database 200 or other sources.

If the resource request is not a request to retrieve a preparation webpage (“NO” of 304), the server module 212 determines whether the resource request is a request by the healthcare provider 102 to post a response (e.g., the response 112) to a questionnaire in one of the preparation webpages (308). If the resource request is a request to post a response to a questionnaire (“YES” of 308), the server module 212 stores the response in the response database 202 (310). The server module 212 can then perform the operation 300 again with regard to another resource request.

If the resource request is not a request to post a response to a questionnaire (“NO” of 308), the server module 212 determines whether the resource request is a request to generate the EHR transition plan 113 (312). In various embodiments, the server module 212 can receive a request to generate the EHR transition plan 113 in various ways. For example, the server module 212 can determine that the resource request is a request to generate the EHR transition plan 113 when the resource request is a request for a webpage that includes the EHR transition plan 113. In another example, the server module 212 can determine that the resource request is a request to generate the EHR transition plan 113 when the resource request is a request to invoke a program that generates a non-webpage document (e.g., a PDF document, a word processor document, or another type of document) containing the EHR transition plan 113.

If the server module 212 determines that the resource request is a request to generate the EHR transition plan 113 (“YES” of 312), the server module 212 generates the EHR transition plan 113 based on the responses provided by the healthcare provider 102 to questionnaires in the preparation webpages (314). In various embodiments, the server module 212 generates the EHR transition plan 113 in various ways. For example, the server module 212 can insert particular responses at appropriate locations within a preprogrammed EHR transition plan template. In this example, the responses can, for instance, include a list of concerns expressed by nurses at the healthcare provider's practice. In this example, the server module 212 inserts the nurses' list of concerns into the EHR transition plan template at a location for nurses' concerns. Furthermore, in some instances, the server module 212 can dynamically generate information based on the responses and insert the dynamically-generated information at locations in the EHR transition plan template. For instance, the server module 212 can dynamically calculate return-on-investment data based on several different responses and insert the return-on-investment data into a location in the EHR transition plan template. After the server module 212 generates the EHR transition plan 113, the server module 212 sends the EHR transition plan 113 to a client device that sent the resource request (e.g., the client device 104) (316). After sending the EHR transition plan 113, the server module 212 can perform the operation 300 again with regard to another resource request.

If the server module 212 determines that the resource request is not a request to generate the EHR transition plan 113 (“NO” of 312), the server module 212 determines whether the resource request is a request by the healthcare provider 102 to generate the RFP 114 (318). If the resource request is to generate the RFP 114 (“YES” of 318), the server module 212 generates the RFP 114 for the healthcare provider 102 based on the responses provided by the healthcare provider 102 to questionnaires in the preparation webpages (320). In various embodiments, the server module 212 generates the RFP 114 in various ways. For example, the server module 212 can insert responses at appropriate locations within a preprogrammed RFP template. In this example, the RFP template can include a location for inserting a device compatibility list that lists devices with which the appropriate EHR system is able to communicate. In this example, when the server module 212 generates the RFP 114, the server module 212 inserts the device compatibility list into the RFP template at this location. Alternatively, in this example, the server module 212 can insert data derived from one or more responses into locations in the RFP template. After generating the RFP 114, the server module 212 can restart the operation 300 with regard to another resource request.

If the resource request is not to generate the RFP 114 (“NO” of 318), the server module 212 determines whether the resource request is a request by the healthcare provider 102 to generate a cover letter (322). If the resource request is a request by the healthcare provider 102 to generate a cover letter (“YES” of 322), the server module 212 generates a cover letter for the RFP 114 (324). The cover letter contains data based on the responses to the questionnaires. For example, the server module 212 can insert particular responses into designated areas within a pre-programmed cover letter template. After generating the cover letter, the server module 212 restarts the operation 300 with regard to another resource request.

If the resource request is not a request to generate a cover letter (“NO” of 322), the server module 212 determines whether the resource request is a request to retrieve a vendor selection page (326). If the resource request is a request for the vendor selection page (“YES” of 326), the server module 212 sends webpage data representing the vendor selection page to the client device that sent the resource request (328). The vendor selection page is a webpage that contains a list of vendors who provide EHR systems. Furthermore, the vendor selection page can include a control that enables the healthcare provider 102 to send vendor selection input to the server 106. After sending the webpage data representing the vendor selection page, the server module 212 restarts the operation 300 with regard to another resource request received by the server 106.

If the resource request is not to retrieve the vendor selection page (“NO” of 326), the server module 212 determines whether the resource request is a vendor selection input from the healthcare provider 102 (330). The vendor selection input indicates one or more vendors. In various embodiments, the healthcare provider 102 can send the vendor selection input to the server 106 in various ways. For example, in some embodiments, the healthcare provider 102 can send the vendor selection input by selecting a submit button on a form in the vendor selection page or another page hosted by the server 106. If the resource request is vendor selection input from the healthcare provider 102 (“YES” of 330), the server module 212 determines whether the RFP 114 and a cover letter have already been generated for the healthcare provider 102 (332). If the RFP 114 and a cover letter have already been generated for the healthcare provider 102 (“YES” of 332), the server module 212 sends the RFP 114 and the cover letter to the vendors indicated by the vendor selection input (334). On the other hand, if either the RFP 114 or the cover letter have not yet been generated for the healthcare provider 102 (“NO” of 332), the server module 212 prompts the healthcare provider 102 to generate the RFP 114 or the cover letter (336). After performing either of actions 328 or 330, the server module 212 restarts the operation 300 with regard to another resource request received by the server 106.

If the resource request is not vendor selection input (“NO” of 330), the server module 212 determines whether the resource request is a request for a vendor portal page (338). If the resource request is for the vendor portal page (“YES” of 338), the server module 212 sends the vendor portal page to the client device that sent the resource request (340). The vendor portal page contains a form that enables a vendor to send a proposal to the server 106. The server module 212 subsequently restarts the operation 300 with regard to another resource request received by the server 106.

If the resource request is not a request for the vendor portal page (“NO” of 338), the server module 212 determines whether the resource request is a request from a vendor to post a proposal (342). If the server module 212 determines that the resource request is a request to post a proposal (“YES” of 342), the server module 212 stores the proposal in the proposal database 204 (344). The server module 212 then notifies the healthcare provider 102 that the server 106 has received a proposal in response to the RFP 114 (346). The server module 212 subsequently restarts the operation 300 with regard to another resource request received by the server 106.

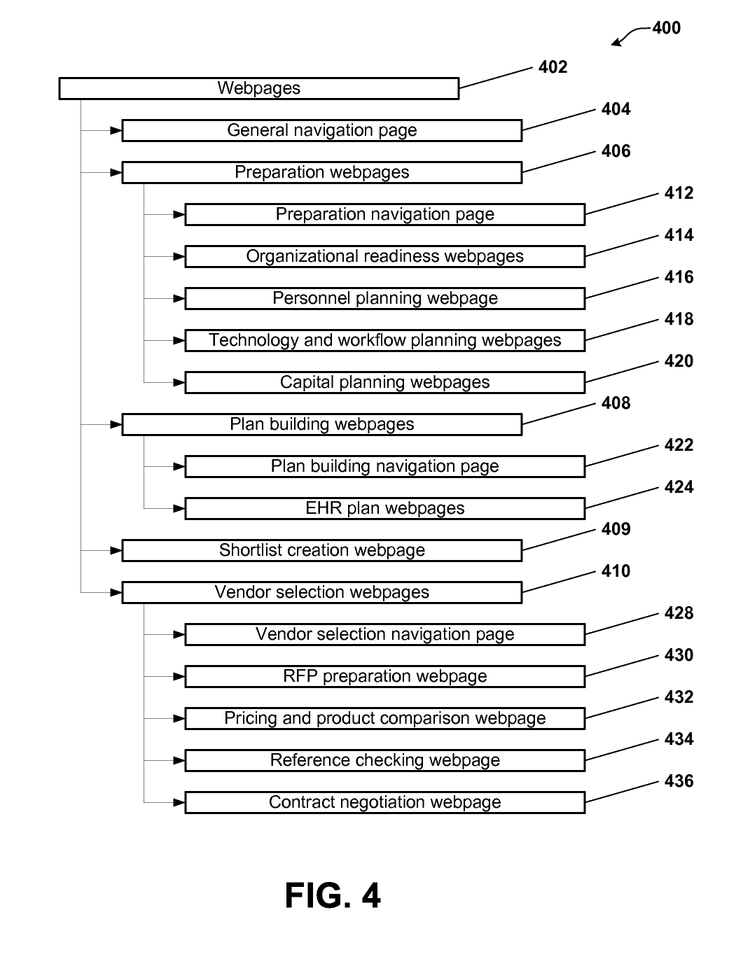

FIG. 4 illustrates an example hierarchy 400 of webpages 402 hosted by the server 106. As illustrated in the example of FIG. 4, the webpages 402 comprise a general navigation page 404, preparation webpages 406, plan building webpages 408, a shortlist creation webpage 409, and vendor selection webpages 410. The preparation webpages 406 help the healthcare provider 102 prepare a description of an EHR system that is appropriate for the healthcare provider's practice and how to transition to the EHR system. The plan building webpages 408 help the healthcare provider 102 to review a description of the appropriate EHR system and how to transition to the EHR system. The shortlist creation webpage 409 helps the healthcare provider 102 to identify a small number of potential vendors who may be able to provide the appropriate EHR system. For example, the shortlist creation webpage 426 can describe a process for how the healthcare provider 102 can narrow a list of vendors down to a few qualified vendors. The vendor selection webpages 410 help the healthcare provider 102 perform a formal process to evaluate and select one of the identified vendors and finalize a deal with the selected vendor.

As illustrated in the example of FIG. 4, the preparation webpages 406 include a preparation navigation page 412, organizational readiness webpages 414, a personnel planning webpage 416, technology and workflow planning webpages 418, and capital planning webpages 420. The preparation navigation page 412 enables the healthcare provider 102 to navigate among the preparation webpages 406. In some embodiments, the preparation navigation page 412 also indicates whether the healthcare provider 102 has provided responses to questionnaires in the preparation webpages 406.

The organizational readiness pages contain questions regarding the readiness of the healthcare provider 102 to adopt an EHR system. In some embodiments, the organizational readiness webpages 414 include a project objectives webpage. The project objectives webpage contains questions related to the objectives of the healthcare provider 102 in transitioning to an EHR system. In various embodiments, the project objectives webpage can include various questions. For example, the project objectives webpage can include questions or prompts such as:
The EHR will help increase revenue for our practice in the following areas (select all that apply):
   Increase number of patients seen and/or reduce the amount of provider time to manage patients.
   Improved coding accuracy and revenue per patient visit.
   Improved capacity to participate in Pay-for-Performance programs.
   Improved ability to attract and retain new providers.
   Uncertain of revenue improvement benefits.
The EHR will help us lower costs in the following areas (select all that apply):
   Reduction or elimination of transcription.
   Reduction or stabilization of medical records staff.
   Reduction in supply/paper costs.
   Uncertain of lower cost benefits.
The EHR will help improve office productivity and efficiency in the following areas (select all that apply):
   Reduction in inefficiencies associated with managing paper charts (i.e. lost charts, filing and administration).
   Improved and rapid access to charts to facilitate daily functions (i.e. prescription refill request).
   Improved legibility and organization of the charts.
   Improved integration with practice management system.
   Uncertain of office productivity benefits.
The EHR will enable our practice to improve customer service and quality of care in the following areas (select all that apply):
   Reduction in response times through improved access to charts (in the office and at home).
   Ability to spend more time with patients.
   Improved quality of care and preventative care for patients.
   Reduction in medical errors.
   Improved communication with patients outside of the office (i.e. patient portal, secure e-mail).
   Improved ability to communicate with referring physicians.
   Improved ability to attract and retain patients.
   Uncertain of customer service and quality of care benefits.
The EHR will help improve regulatory compliance and interaction with third parties (select all that apply):
Better ability to comply with third party requests for information and regulatory audits.
Improved malpractice risk management.
Uncertain of regulatory compliance and third party benefits.
   The following are additional objectives for our project not noted above . . . ”
What are your biggest concerns about the transition to EHR (select all that apply):
   Provider resistance to change and impact on physician productivity.
   Staff resistance to change and impact on staff productivity.
   Ability to successfully manage implementation.
   The expense of the system.
   Other concerns.
We plan to address these concerns in the following ways (select all that apply):
   Open discussions with providers and staff re: goals and objectives of the project.
   Provider and staff involvement in preparation and selection process.
   Appropriate staffing to support the selection and implementation process.
   Careful budgeting and competitive pricing to help insure expense management.
   Uncertain of how we address concerns.
   Other strategies.

The organization readiness webpages 414 also include a providers and staff readiness webpage. The providers and staff readiness webpage enables the healthcare provider 102 to input the results of a survey of providers and staff regarding their readiness to transition to an EHR system. For example, the survey can include questions or prompts that can be answered with “yes,” “no,” or “not sure” responses. In this example, the survey can include questions or prompts such as:
“The transition to EHR will be good for the practice as a whole.”
“The transition to EHR will be good for me, personally.”
“I am willing to invest additional time to learn how to use the EHR.”
“I am interested in actively participating in the EHR selection and implementation process.”
“I am concerned about the expense of the system for the practice.”
“I am concerned about the impact on my productivity.”
“I am concerned about the impact on my ability to interact with patients.”
“I am concerned about my level of computer skills.”
“Do you use a computer at home or work?”
“Do you use Windows or Windows applications?”
“Do you routinely use e-mail?”
“Do you know how to attach files to an e-mail message?”
“Are you comfortable with opening and reviewing PDF files?”
   In some embodiments, the providers and staff readiness webpage includes scripts that calculate and display response rate percentages for questions or prompts in the survey. The providers and staff readiness webpage can also include fields for entering free text responses to the following prompts:
“The following are concerns expressed by staff and providers regarding the EHR project.”
“Staff that may need additional computer training proper to deployment of the EHR.”
“Staff that can service as leaders for the EHR project”

The organization readiness webpages 414 also include a project timing webpage. The project timing webpage helps the healthcare provider 102 to identify a timeline for transitioning to an EHR system. For example, the project timing webpage can prompt the healthcare provider to enter the following information:
Completion date of planning phase.
Completion date of vendor selection phase.
Date for initiation of implementation.
Go-live date.

The personnel planning webpage 416 contains questions that prompt the healthcare provider 102 to select people to participate in the process of transitioning the healthcare provider's practice to an EHR system. For example, the personnel planning webpage 416 can include text areas that allow the healthcare provider to enter names of people having various roles to assist in the planning and selection phase of the transition process, the implementation phase of the transition process, and the post-implementation phase of the transition process. These roles can include the following: “physician leader/committee chair,” “project manager,” “hardware and network analyst,” “EHR analyst,” “EHR consultant,” “Network/Hardware consultant,” “other consultants,” and representatives of departments. The representatives of departments can include representatives from a providers department, a nursing department, an administration department, and a medical records department.

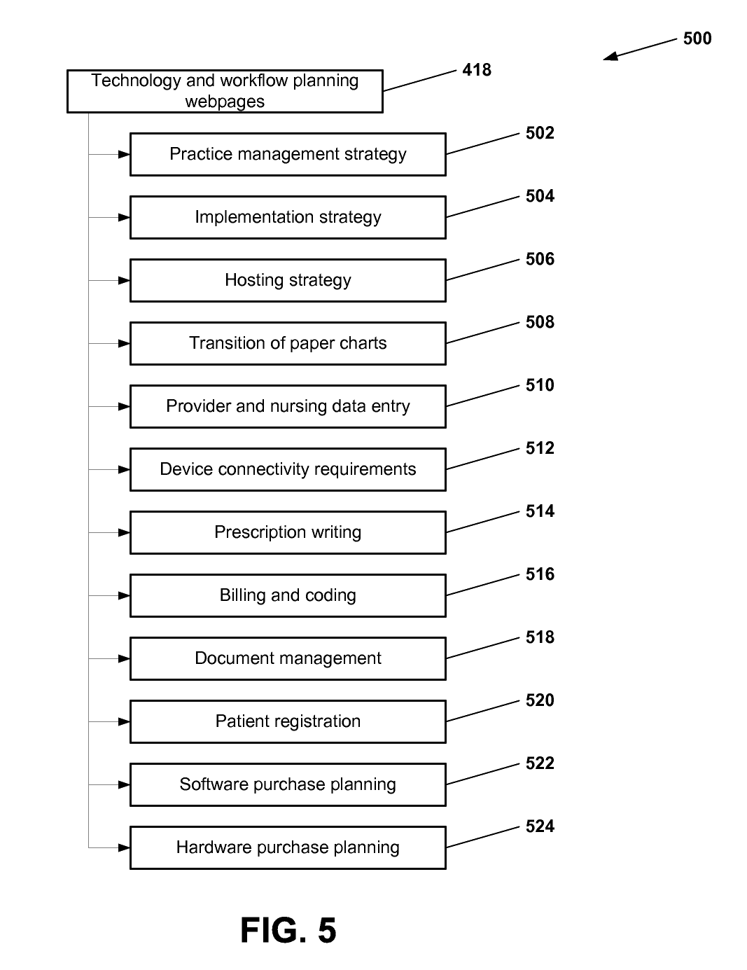

FIG. 5 illustrates an example hierarchy 500 of webpages within the technology and workflow planning webpages 418. As illustrated in the example of FIG. 5, the technology and workflow planning webpages 418 include a practice management strategy webpage 502, a implementation strategy webpage 504, a hosting strategy webpage 506, a transition of paper charts webpage 508, a provider and nursing data entry webpage 510, a device connectivity requirements webpage 512, a prescription writing webpage 514, a billing and coding webpage 516, a document management webpage 518, a patient registration webpage 520, a software purchase planning webpage 522, and a hardware purchase planning webpage 524.

The practice management strategy webpage 502 includes questions related to how the healthcare provider 102 wants to integrate practice management software into the EHR system. For example, the practice management strategy webpage 502 can include the following prompts:
Our practice management software plan is:
   We plan to keep our practice management system and purchase an electronic medical record that interfaces to it.
   We plan to discontinue use of our existing practice management system and purchase an integrated electronic health records and practice management system.
   We plan to continue to outsource our medical billing to a third party and purchase an electronic health record system that also allows registration and scheduling
   We are uncertain about our practice management software plan.
From a patient demographics and registration perspective, we are planning (select one):
   To transfer patient demographics from our existing system into the new integrated EHR/practice management system. We feel comfortable with the quality of our existing patient demographic data.
   To re-register all patients into the new integrated EHR/practice management system because we do not feel comfortable with the quality of the patient demographic data or the ability to effectively retrieve this data.
   We are uncertain about our patient demographics plan.

The implementation strategy webpage 504 includes questions that help the healthcare provider 102 to identify a desired implementation strategy for the EHR system. For example, the implementation strategy webpage 504 can include questions such as:
Our EMR implementation plan (select one):
   Deploy the major components of the EHR at go-live, including progress note generation, prescription writing, messaging, nursing notes, and active transition information in paper charts into the EHR (Big Bang).
   Deploy individual components of the EHR such as prescription writing in an incremental fashion, leading to a more gradual transition to the full EHR (Incremental).
   We are uncertain about our EHR implementation plan.
We hope to “retire” the majority of our active paper charts according to the following schedule (select one):
   Within 12 months of go-live.
   Within 24 months of go-live.
   Within 36-48 months of go-live.
   We do not plan on retiring our paper charts.
   We are uncertain about our plans regarding paper charts.
We are planning to stage the implementation in the following way: (select one)
   Go-live with EHR with an interface to our existing practice management system.
   Simultaneously go-live with new practice management and with EHR.
   Go live with new practice management first, followed by EHR.
   Go live with EHR first, followed by new practice management.
   We are uncertain about the timing of implementation.

The hosting strategy webpage 506 includes questions that help the healthcare provider 102 determine an appropriate technology to host the EHR system. For example, the hosting strategy webpage 506 can include questions such as:
Our EHR hosting plan: (select one)
   Install the software locally on a server resident in our facility using a client server application with a “thick” client deployment for individual workstations
   Install the software locally on a server resident in our facility using a client server application with a “thin” client deployment for individual workstations
   Install the software locally on a server resident in our facility using a client server application with a mix of “thick” and “thin” client deployment for individual workstations
   Install the software remotely through a hosted service (i.e. application service provider)
   We are uncertain about our EHR hosting plan

The transition of paper charts webpage 508 includes questions that help the healthcare provider 102 determine how to transition paper charts to electronic medical records. The healthcare provider's responses to the questions constitute a paper chart transition strategy that the healthcare provider 102 provides to the server 106. The paper chart transition strategy indicates how the healthcare provider 102 intends to transition paper charts to electronic health records. In various embodiments, the transition of paper charts webpage 508 includes various questions. For example, the transition of paper charts webpage 508 can include questions such as:
We are planning on using the following method for transitioning paper charts to the EHR: (select one)
   Abstracting relevant portions of the paper chart for direct entry into the EHR.
   Scanning relevant portions of the paper chart for “attachment” to the EHR.
   A combination of scanning and abstracting the paper chart information into the EHR.
   Scanning of the entire chart for “attachment” to the EHR.
The following staff will be responsible for determining what portion are either scanned or abstracted from the paper chart to the EHR: (select one)
   The provider responsible for the patient.
   The provider's nurse.
   Other third party (i.e. medical student).
The following information will be scanned or abstracted from the paper chart to the EHR: (select all that apply)
   Allergies.
   Current medications.
   Current problem lists.
   Recent laboratory or special studies results.
   Social and family history.
   Most recent progress note.
   Other.
Information will be scanned or abstracted from the paper chart to the EHR: (select one)
   Before the patient is seen, based on the practice's schedule.
   After patient is seen, based on the practice's schedule.
   Other method.
The staff responsible for abstracting information will use the following method for data entry into the EHR: (select one)
   Dictation of a summary progress note for “downloading” into the EHR.
   Manual entry of a summary progress note for direct entry into the EHR.
   A combination of dictation and manual entry.
   Other method.
The following staff will be responsible for scanning selected portions of the chart for inclusion in the EHR: (select one)
   The provider's nurse or medical assistant.
   Medical records staff
   Other third party (i.e. temporary labor).
   Not applicable: we do not plan on using scanning as part of our paper chart transition process.
After completion of the chart abstraction, the paper chart will be managed in the following way: (select one)
   Marked as “transitioned” and placed in a separate “retired chart” location for access by request.
   Marked as “transitioned” and re-filed among the general charts for access by request.
   Other.

The device connectivity webpage 512 includes questions that prompt the healthcare provider 102 to identify the types of devices with which the EHR system will need to communicate. Such devices can include medical devices (such as otoscopes, digital X-ray machines, etc.) and non-medical devices (such as voice recording devices, voicemail systems, communication servers, etc.). The healthcare provider 102 provides device compatibility data to the server 106 in response to the questions in the device connectivity webpage 512. The device compatibility data identifies the types of devices with which the appropriate EHR system need to communicate. In various embodiments, the device connectivity webpage 512 can include various questions. For example, the device connectivity webpage 512 can include the following questions:
We are planning the following as it relates to the collection of vital signs (select all that apply):
   Manually collected and entered by nurse directly into the EHR.
   Collected by an electronic vital sign device and electronically transferred to the EHR.
   Collected by an electronic vital sign device on a mobile stand and manually entered into the EHR.
   Collected in a centrally located vitals triage station.
   Collected in individual exam rooms.
   To be determined: we are uncertain about our plan as it relates to vital signs.
We are planning the following as it relates to the collection of resting ECG data (select all that apply):
   Collected using existing ECG equipment; tracings scanned into the EHR by our medical records staff.
   Collected using new ECG equipment that is capable of electronically storing ECG data into the EHR.
   Collected in an ECG procedure room.
   Collected in all exam rooms as required.
   To be determined: we are uncertain about our plan as it relates to resting ECG.
   Not applicable: we do not use resting ECG.
We are planning the following as it relates to the collection of spirometry data (select all that apply):
   Collected using existing spirometry equipment; spirometry data scanned into the EHR by our medical records staff
   Collected using new spirometry equipment that is capable of electronically storing spirometry data into the EHR.
   Collected in a spirometry room.
   Collected in all exam rooms, as required.
   To be determined: we are uncertain about our plan as it relates to spirometry.
   Not applicable: we do not use spirometry.
Other devices we hope to integrate with EHR (select all that apply):
   Holter monitors.
   Stress test.
   Ambulatory blood pressure monitors.
   Digital otoscope.
List any other devices

The prescription writing webpage 514 includes questions that help the healthcare provider 102 determine how the EHR system will document prescriptions. The healthcare provider's responses to the questions in the prescription writing webpage 514 constitute a prescription writing strategy that the healthcare provider 102 sends to the server 106. The prescription writing strategy indicates how the healthcare provider 102 intends to document prescriptions after the EHR system is deployed. In various embodiments, the prescription writing webpage 514 includes various questions. For example, the prescription writing webpage 514 can include questions such as:
We are planning on managing prescriptions in the following way (select one)
   Prescriptions will be printed at local printers either in the exam room or outside the exam room.
   Prescriptions will be electronically sent through the Surescripts/RxHUB network directly to pharmacies.
   Prescriptions will be electronically faxed to pharmacies using an integrated fax server.
   To be determined: we are uncertain about how prescriptions will be handled.

The billing and coding webpage 516 includes questions that help the healthcare provider 102 determine how the appropriate EHR system will handle billing and coding. For example, the billing and coding webpage 516 can include questions such as:
We are planning on managing our billing process as it pertains to providers and superbills in the following way: (select one)
We will continue to use paper superbills.
We will use electronic encounter form.
We will use paper superbills in the beginning of our project and transition to the electronic encounter form over time.
To be determined: we are uncertain about how our billing process will be handled as it pertains to providers and superbills.
Not applicable.

The document management webpage 518 includes questions that help the healthcare provider 102 determine how the appropriate EHR system will manage documents. For example, the document management webpage 518 may include questions such as:
We are planning on using the following methods for scanning incoming documents (select one):
   Scanning and indexing of scanned images.
   Optical character recognition (OCR) of scanned images and filing of “OCRed” text document.
   Combination of scanning and OCR.
   Uncertain of scanning methods.
The following incoming documents will be scanned and saved within the EHR (select all that apply):
   Consult letters and reports.
   Laboratory results and imaging studies for facilities in which we do not have an interface.
   Patient correspondence to the practice.
   Other documents.
The following personnel will be responsible for document management including scanning of paper documents, filing within the EHR and receipt and filing of electronically received documents (other than those received by interfaces).
Scanning of paper documents will be performed at the locations noted below.
The following third parties that send our practice a high volume of paper documents (excluding those for which we have interfaces) have agreed to send us documents electronically.

The patient registration webpage 520 includes questions that help the healthcare provider 102 decide how or whether the appropriate EHR system will handle patient registration. For example, the patient registration webpage 520 can include questions such as:
We are planning on managing patient registration in the following way (select one):
   No change: we will continue to use our existing practice management system that will have a registration interface to our EHR.
   Dual registration: we will continue to use our existing practice management system and will also enter patient registration data in the EHR.
   Patient Registration using our new integrated practice management system. To minimize additional data entry, we will be converting patient demographic data from our existing practice management system to our new PM system.
   Patient Registration using our new integrated practice management system. We will not be converting patient demographics from our existing practice management system and therefore will be manually re-registering existing patient demographic data into new system.
We are planning to capture the following elements in a “paperless” fashion (select all that apply):
   Insurance cards and drivers licenses.
   Patient signatures.
   Patient photographs.
   Patient questionnaires.
   Other.

The software purchase planning webpage 522 includes questions that help the healthcare provider 102 to determine what software will be included in the appropriate EHR system. For example, the software purchase planning webpage 520 can include questions that prompt the healthcare provider 102 to indicate whether the following software system will be included in the appropriate EHR system:
Patient Education.
Drug to Drug Interaction checking
Formulary Management.
SureScripts/RX HUB Connectivity.
Clinical Content.
Customization Tools.
E & M Coding Wizard.
Order Entry.
Voice Recognition.
Integrated Patient History.
Electronic vital signs monitors device connectivity.
Resting ECG device connectivity.
Spirometry device connectivity.
Holter monitors device connectivity.
Stress test device connectivity.
Ambulatory blood pressure monitors device connectivity.
Digital otoscope device connectivity.
Document management software.
Fax server software.
Practice management software.
Practice management conversion software.
Claims management “scrubbing” tool.
Electronic claims clearinghouse services.
Electronic remittance clearinghouse services.
Eligibility clearinghouse services.
Claims management tool clearinghouse services.
Patient statements clearinghouse services.
Secure email patient portal services.
Personal health record patient portal services.
   The software purchase planning webpage 522 can also include questions that prompt the healthcare provider 102 to indicate practice management software interfaces that the appropriate EHR system will include. Such practice management software interfaces can include a registration interfaces, a scheduling interface, a charges interface, and other types of interfaces between the appropriate EHR system and practice management software

The software purchase planning webpage 522 can also include questions that prompt the healthcare provider 102 to identify clinical reference labs with which the EHR system will be able to interface. In addition, the software purchase planning webpage 522 can include questions that prompt the healthcare provider 102 to identify imaging centers, hospitals, and Health Information Exchanges/Regional Health Information Organizations with which the EHR system will be able to interface.

The hardware purchase planning webpage 524 includes questions that prompt the healthcare provider 102 to identify how many devices of various types the healthcare provider 102 intends to purchase for various people and locations. For example, the types of devices can include:
Tablets.
Laptops.
Desktops.
Rx/Patient Printers.
Report scanners.
Lab interface workstations.
Fax server workstations.
   The people and locations can include:
Providers.
Nurses.
Other individuals.
Provider offices.
Exam rooms.
Nursing/MA stations.
Provider stations.
Telephone triage stations.
Administration offices.
Medical records stations.
Front desk/reception.
Appointment scheduling.
Server room.
   In some embodiments, the hardware purchase planning webpage 524 dynamically displays total numbers of hardware elements for each of the types of device and/or people and locations.

Continuing reference is now made to FIG. 4. In some embodiments, the capital planning webpages 420 include an EHR expense estimate webpage. The EHR expense estimate webpage includes questions that help the healthcare provider 102 to estimate the expenses incurred by obtaining and transitioning to the EHR system. For example, the EHR expense estimate webpage can include questions that help the healthcare provider calculate its estimated five-year EHR expense and the impact of transitioning to the EHR system on physician productivity. In addition, the EHR expense estimate webpage can dynamically display total 5-year expense estimates for each type of expense incurred in obtaining and transitioning to the EHR system. These 5-year expense estimates can be calculated in various ways. For example, the 5-year expense estimates can be calculated at the server 106. Alternatively, the client device 104 can run one or more scripts in the EHR expense estimate webpage to calculate the 5-year expense estimates.

Furthermore, in some embodiments, the capital planning webpages 420 also include a revenue improvement and cost reductions webpage. The revenue improvement and cost reductions webpage helps the healthcare provider 102 to determine how an EHR system could improve revenue and reduce costs. For example, the revenue improvement and cost reductions webpage can include questions that help the healthcare provider 102 to determine the increased revenue due to visit coding, increased revenue due to increased patient visits, decreased costs due to reduced transcription expenses, and decreased costs due to reduced labor expenses. In addition, the revenue improvement and cost reductions webpage can dynamically display total 5-year revenue improvement estimates for various types of revenue increases or cost decreases. These 5-year revenue improvement estimates can be calculated in various ways. For example, the 5-year revenue improvement estimates can be calculated at the server 106. Alternatively, the client device 104 can run one or more scripts in the revenue improvement and cost reductions webpage to calculate the 5-year revenue improvement estimates.

The capital planning webpages 420 can also include a return on investment webpage. The return on investment webpage displays a projected return on investment for the healthcare provider 102. Furthermore, in some embodiments, the return on investment webpage displays projected 5-year net revenue gains and a payback period. The server 106 calculates the projected return on investment, the projected 5-year net revenue gains, and the payback period based on the responses provided by the healthcare provider 102 in the EHR expense estimate webpage and the revenue improvement and cost reductions webpage.

The plan building webpages 408 include a plan building navigation page 422 and an EHR plan webpage 424. The plan building navigation page 422 contains an introductory discussion of the plan building webpages 408 and helps the healthcare provider 102 navigate to the EHR plan webpage 424. In some embodiments, the plan building navigation page 422 also contains a link that enables the healthcare provider 102 to navigate to the shortlist creation webpage 409. The EHR plan webpage 424 contains the EHR transition plan 113. As discussed above, the EHR transition plan 113 summarizes the readiness of the healthcare provider 102 to adopt the EHR system, how the healthcare provider 102 intends to use the EHR system in the workflows performed by the healthcare provider 102, and how the healthcare provider 102 intends to implement the EHR system. In some embodiments, the EHR transition plan 113 also provides guidance on how to conduct a formal vendor evaluation and selection process. The EHR transition plan is based on the responses provided by the healthcare provider 102 to questions in the preparation webpages 406.

The vendor selection webpages 410 include a vendor selection navigation page 428, a RFP preparation webpage 430, a pricing and product comparison webpages 432, a reference checking webpage 434, and a contract negotiation webpage 436. The vendor selection navigation page 428 helps the healthcare provider 102 navigate among the RFP preparation webpages 430, the pricing and product comparison webpages 432, the reference checking webpage 434, and the contract negotiation webpage 436.

The RFP preparation webpages 430 include a webpage that allows the healthcare provider 102 to review the RFP 114 generated for the healthcare provider 102 by the server 106. The RFP preparation webpages 430 also include a vendor selection webpage. The vendor selection webpage enables the healthcare provider 102 to send the RFP 114 to vendors selected by the healthcare provider 102. Furthermore, the RFP preparation webpages 430 include a product demonstrations webpage that provides guidelines for setting up and conducting product demonstrations from the selected vendors.

In various embodiments, the RFP 114 asks a vendor to provide various types of information. For example, in some embodiments, the RFP 114 asks the vendor to provider the following:
A name, title, email, and phone number for a sales representative for managing the healthcare provider's account.
Estimated annual revenue from EHR/practice management software and services.
Total number of employees supporting EHR/practice management products (includes sales, service, product development, operations).
Number of EHR installations.
Number of EHR installations within a practice category specified by the healthcare provider 102.
Number of practice management installations.
Number of practice management installations within a practice category specified by the healthcare provider 102.
Average size (in terms of number of providers) of installations.
Content that the vendor has for the healthcare provider's specialty.
Third party endorsements or awards received in the last three years.
Provide 2 references in a practice category specified by the healthcare provider 102, including contact information.
Preferred business relationships the vendor may have with hospitals, IPAs, or other regional organizations that would be relevant to our practice.
EHR product name and current shipping version.
CCHIT Certifications status for the various years.
Whether the vendor's product currently supports the CCD standard for interoperability between EHRs.
Practice management product name and current shipping version.
Whether the currently available practice management system is fully integrated with the

EHR (full integration is defined as the use of a single database for both applications eliminating the need for interfaces between the two systems).
Availability of EHR options selected by the healthcare provider 102 in the preparation webpages 406.
Availability of device connectivity of the vendor's EHR system with devices specified by the healthcare provider 102 in the preparation webpages 406.
Availability of EHR-Practice Management Interfaces specified by the healthcare provider 102 in the preparation webpages 406.
Availability of EHR-Clinical Reference Lab Interfaces with lab results providers specified by the healthcare provider 102 and with lab order providers specified by the healthcare provider 102.
Availability of the EHR system to interface with an imaging center specified by the healthcare provider 102.
Availability of the EHR system to interface with a hospital specified by the healthcare provider 102.
Availability of the EHR system to interface with a health information exchange or regional health information organization specified by the healthcare provider 102.
Availability of the EHR system to include or interface with practice management software, as specified by the healthcare provider 102.
Availability of the EHR system to use the clearinghouse services specified by the healthcare provider 102.
Availability of the patient portal services specified by the healthcare provider 102.
Summaries of pricing information.
Breakdown of service expenses.
Availability of hardware procurement services, network configuration services, hardware installation services, and network cabling services from the vendor.

The pricing and product comparison webpages 432 include a pricing comparison webpage. The pricing comparison webpage contains guidelines to help the healthcare provider 102 compare proposals received from the selected vendors in response to the RFP 114. The pricing and product comparison webpages 432 also include a vendor scorecard webpage. The vendor scorecard webpage contains guidelines that help the healthcare provider rank each vendor by category. Such categories can include: experience, content, practice management, CCHIT certification, product offering, product demonstration, pricing, hardware and networking service, and references/site visits. Ranking each vendor by category can help the healthcare provider 102 to choose a final vendor for contract negotiations.

The reference checking webpage 434 contains guidelines that help the healthcare provider 102 effectively interview other practices regarding their EHR experiences. The contract negotiation webpage 436 contains guidelines that help the healthcare provider 102 successfully negotiate a contract with a vendor.

The general navigation page 404 comprises links that help the healthcare provider 102 navigate to other ones of the webpages 402. For example, the general navigation page 404 can contain general introductory information about the EHR preparation and selection service and can include links to webpages such as the preparation navigation page 412, the plan building navigation page 422, and the vendor selection navigation page 428.

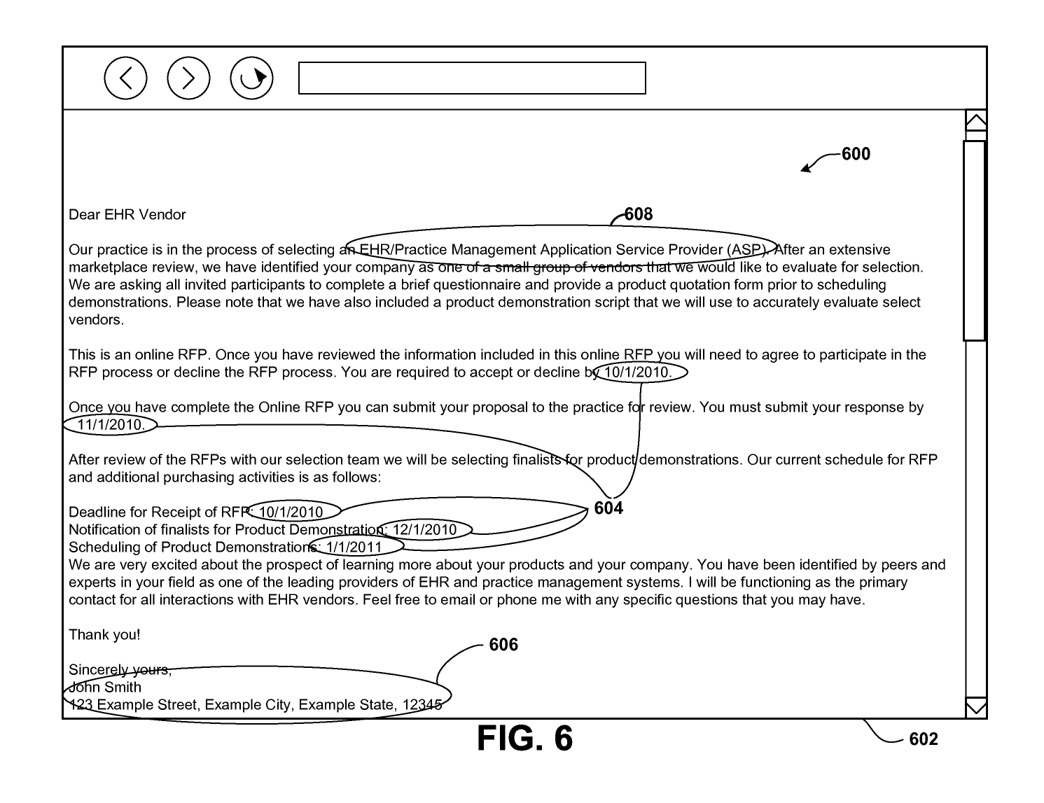

FIG. 6 illustrates an example cover letter 600 generated by the server 106. In the example of FIG. 6, the cover letter 600 is displayed in a window 602 of a web browser application. Most of the cover letter 600 is preprogrammed. However, the server 106 automatically inserts dates 604 into the cover letter 600. The healthcare provider 102 provides the dates 604 as responses to RFP activity timing questions in the preparation webpages 406. The RFP activity timing questions are questions that relate to the timing of various events in the healthcare provider's planned transition to an EHR system. Furthermore, the server 106 automatically inserts contact information 606 for the healthcare provider 102 into the cover letter. The server 106 also inserts text 608 that briefly indicates a type of EHR system that the healthcare provider 102 is planning to deploy. The text 608 is based on responses provided by the healthcare provider 102 in the preparation webpages 406.

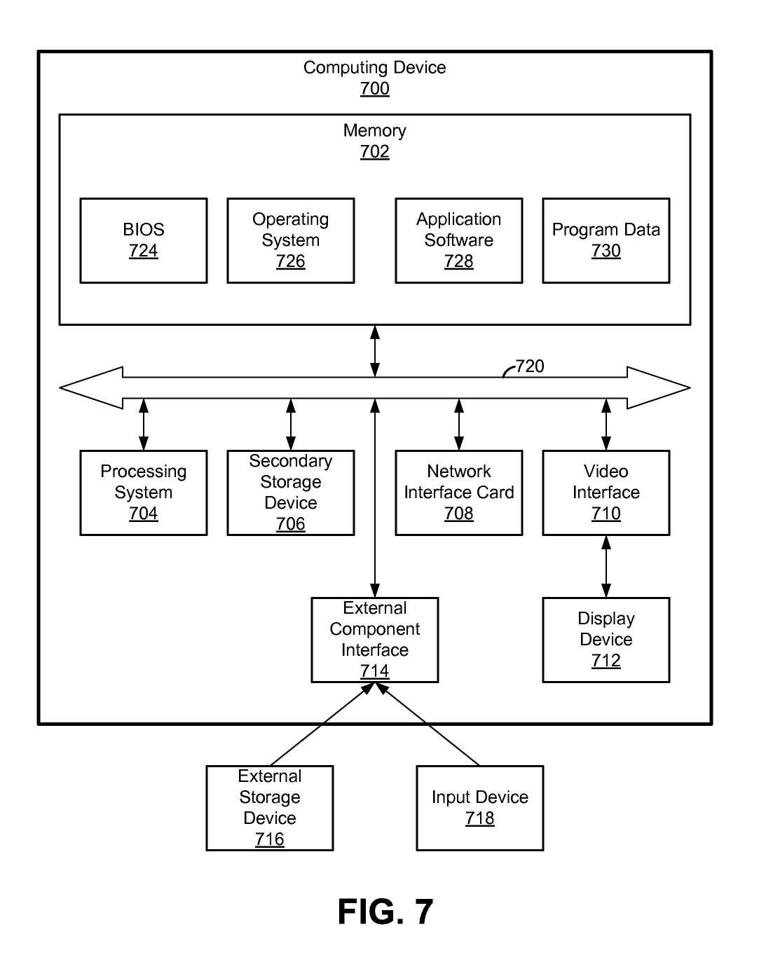

FIG. 7 is a block diagram illustrating an example computing device 700. In some embodiments, the client device 104, the server 106 and/or the client device 116 comprise one or more computing devices like the computing device 700. It should be appreciated that in other embodiments, the client device 104, the server 106 and/or the client device 116 are provided by computing devices having hardware components other than those illustrated in the example of FIG. 7.

In different embodiments, computing devices are implemented in different ways. In the example of FIG. 7, the computing device 700 comprises a memory 702, a processing system 704, a secondary storage device 706, a network interface card 708, a video interface 710, a display device 712, an external component interface 714, an external storage device 716, an input device 718, and a communication medium 720. In other embodiments, computing devices are implemented using more or fewer hardware components. For instance, in another example embodiment, a computing device does not include a video interface, a display device, an external storage device, or an input device.

The term computer-readable media as used herein may include computer-readable storage media. Computer-readable storage media include devices or articles of manufacture that store data and/or computer-executable instructions readable by a computing device. Computer-readable storage media can be volatile or nonvolatile and can be removable or non-removable. Computer-readable storage media can store various types of information, including computer-executable instructions, data structures, program modules, or other data. Example types of computer-readable storage media include, but are not limited to, dynamic random access memory (DRAM), double data rate synchronous dynamic random access memory (DDR SDRAM), reduced latency DRAM, DDR2 SDRAM, DDR3 SDRAM, solid state memory, flash memory, read-only memory (ROM), electrically-erasable programmable ROM, magnetic disks, magnetic tape drives, CD-ROM discs, DVD-ROM discs, Blu-Ray discs, Bernoulli cartridges, and other types of devices and/or articles of manufacture that store data.

The memory 702 includes one or more computer-readable storage media capable of storing data and/or computer-executable instructions. In different embodiments, the memory 702 is implemented in different ways. For instance, in various embodiments, the memory 702 is implemented using various types of computer-readable storage media.

The term computer-readable media as may also include communication media. Computer readable instructions, data structures, program modules, or other data in a modulated data signal, such as a carrier wave or other transport mechanism, may be embodied in a communication medium. The term “modulated data signal” may describe a signal that has one or more characteristics set or changed in such a manner as to encode information in the signal. For example, communication media can include wired media such as a wired network or direct-wired connection, and wireless media such as acoustic, radio frequency (RF), infrared, and other wireless media.

The processing system 704 includes one or more processing units. A processing unit is an integrated circuit that selectively executes computer-executable instructions. In various embodiments, the processing system 704 is implemented in various ways. For example, the processing system 704 can comprise one or more processing cores. In another example, the processing system 704 can comprise one or more separate microprocessors. In yet another example, the processing system 704 can comprise one or more ASICs that provide specific functionality. In yet another example, the processing system 704 can provide specific functionality by using an ASIC and by executing software instructions.

The secondary storage device 706 includes one or more computer-readable storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 is implemented by various types of computer-readable storage media.

The network interface card 708 enables the computing device 700 to send data to and receive data from a communications medium, such as a computer communication network. In different embodiments, the network interface card 708 is implemented in different ways. For example, the network interface card 708 can be implemented as an Ethernet interface, a fiber optic network interface, a wireless network interface (e.g., WiFi, 3G, 4G, WiMax, etc.), a modem, or another type of network interface.

The video interface 710 enables the computing device 700 to output video information to the display device 712. In different embodiments, the video interface 710 is implemented in different ways. For instance, in one example embodiment, the video interface 710 is integrated into a motherboard of the computing device 700. In another example embodiment, the video interface 710 is a video expansion card.

In various embodiments, the display device 712 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 710 communicates with the display device 712 in various ways. For instance, in various embodiments, the video interface 710 communicates with the display device 712 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 714 enables the computing device 700 to communicate with external devices. In various embodiments, the external component interface 714 is implemented in different ways. For instance, in one example embodiment, the external component interface 714 is a USB interface. In other example embodiments, the computing device 700 is a FireWire interface, a serial port interface, a parallel port interface, a PS/2 interface, and/or another type of interface that enables the computing device 700 to communicate with external components.

The external storage device 716 is an external component comprising one or more computer readable data storage media. Different implementations of the computing device 700 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 718 is an external component that provides user input to the computing device 700. Different implementations of the computing device 700 interface with different types of input devices. Example types of input devices include, but are not limited to, keyboards, mice, trackballs, stylus input devices, key pads, microphones, joysticks, touch-sensitive display screens, and other types of devices that provide user input to the computing device 700.

The communications medium 720 facilitates communication among the hardware components of the computing device 700. In different embodiments, the communications medium 720 facilitates communication among different components of the computing device 700. For instance, in the example of FIG. 7, the communications medium 720 facilitates communication among the memory 702, the processing system 704, the secondary storage device 706, the network interface card 708, the video interface 710, and the external component interface 714. In different implementations of the computing device 700, the communications medium 720 is implemented in different ways. For instance, in different implementations of the computing device 700, the communications medium 720 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 724, an operating system 726, application software 728, and program data 730. The BIOS 724 includes a set of computer-executable instructions that, when executed by the processing system 704, cause the computing device 700 to boot up. The operating system 726 includes a set of software instructions that, when executed by the processing system 704, cause the computing device 700 to provide an operating system that coordinates the activities and sharing of resources of the computing device 700. Example types of operating systems include, but are not limited to, MICROSOFT® WINDOWS®, Linux, Unix, Apple OS X, Apple iOS, Google Chrome OS, Google Android OS, and so on. The application software 728 includes a set of software instructions that, when executed by the processing system 704, cause the computing device 700 to provide applications. The program data 730 is data generated and/or used by the application software 728.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

1. A method for helping a healthcare provider to select an electronic health record (EHR) system that is appropriate for the healthcare provider's practice, the method comprising:
providing, by a server, preparation webpages to the healthcare provider, the preparation webpages including questionnaires to be completed by the healthcare provider;
receiving, by the server, responses to the questionnaires;
generating, by the server, a request for proposal (RFP), the RFP requesting a proposal for providing the EHR system to the healthcare provider, the RFP containing a description of the EHR system, the server generating the description of the EHR system based on the responses to the questionnaires;
receiving, by the server, vendor selection input, the vendor selection input indicating a selected vendor; and
sending, by the server, the RFP to the selected vendor.

2. The method of claim 1, further comprising:
receiving, by the server, the proposal from the selected vendor in response to the RFP; and
providing, by the server, the proposal to the healthcare provider.

3. The method of claim 2, further comprising:
sending, by the server, a vendor portal webpage to the selected vendor, the vendor portal page containing a form that enables the selected vendor to send the proposal to the server.

4. The method of claim 1,
wherein providing the preparation webpages to the healthcare provider comprises:
providing organizational readiness webpages to the healthcare provider, the organizational readiness webpages containing questions regarding a readiness of the healthcare provider to adopt the EHR system;
providing technology and workflow planning webpages to the healthcare provider, the technology and workflow planning webpages containing questions regarding how the healthcare provider intends to use the EHR system in workflows performed by the healthcare provider, the technology and workflow planning webpages containing questions regarding how the healthcare provider intends to implement the EHR system; and
wherein the method further comprises:
generating an EHR transition plan based on the responses, the EHR transition plan summarizing the readiness of the healthcare provider to adopt the EHR system, how the healthcare provider intends to use the EHR system in the workflows performed by the healthcare provider, and how the healthcare provider intends to implement the EHR system; and
providing the EHR transition plan to the healthcare provider.

5. The method of claim 4,
wherein providing the preparation webpages further comprises providing a personnel planning webpage to the healthcare provider, the personnel planning webpage containing questions that prompt the healthcare provider to select people to participate in a process of transitioning the healthcare provider's practice to the EHR system;
wherein receiving the responses comprises receiving data indicating the selected people; and
wherein the EHR transition plan lists the selected people.

6. The method of claim 1,
wherein receiving the responses comprises receiving data that indicates a paper chart transition strategy, the paper chart transition strategy indicating how the healthcare provider intends to transition paper charts to electronic health records; and
wherein generating the RFP comprises specifying the paper chart transition strategy.

7. The method of claim 1,
wherein receiving the responses comprises receiving data that identifies types of devices with which the EHR system is able to communicate; and
wherein generating the RFP comprises listing the types of devices in the description of the EHR system.

8. The method of claim 1,
wherein receiving the responses comprises: receiving data that indicates patient portal services that the EHR system provides; and
wherein generating the RFP comprises: specifying the patient portal services in the description of the EHR system.

9. The method of claim 1,
wherein receiving the responses comprises receiving data that indicates a practice management strategy, the practice management strategy indicating how the EHR system integrates with practice management software; and
wherein generating the RFP comprises: specifying the practice management strategy in the description of the EHR system.

10. The method of claim 1,
wherein receiving the responses comprises receiving data that indicates a prescription writing strategy, the prescription writing strategy indicating how the healthcare provider intends to manage prescription writing after the EHR system is deployed; and
wherein generating the RFP comprises: specifying the prescription writing strategy in the description of the EHR system.

11. The method of claim 1, further comprising:
generating, by the server, a cover letter for the RFP, the cover letter containing data based on the responses; and
sending, by the server, the RFP to the selected vendor.

12. A computing device that provides an EHR selection service that helps a healthcare provider to select an EHR system, the computing device comprising:
a processing unit; and
a memory that stores computer-executable instructions that, when executed by the processing unit, cause the computing device to:
provide preparation webpages to the healthcare provider, the preparation webpages including questionnaires to be completed by the healthcare provider;
generate a request for proposal (RFP), the RFP requesting a proposal for providing the EHR system to the healthcare provider, the RFP containing a description of the EHR system, the server generating the description of the EHR system based on responses to the questionnaires, the responses received from the healthcare provider; and
send the RFP to a selected vendor, the selected vendor identified by vendor selection input received from the healthcare provider.

13. The computing device of claim 12, wherein the computer-executable instructions further cause the computing device to:
store a proposal received from the selected vendor in response to the RFP; and
provide the proposal to the healthcare provider.

14. The computing device of claim 13, wherein the computer-executable instructions further cause the computing device to send a vendor portal webpage to the selected vendor, the vendor portal page containing a form that enables the selected vendor to send the proposal to the server.

15. The computing device of claim 12,
wherein the computer-executable instructions, when executed, cause the computing device to:
provide organizational readiness webpages to the healthcare provider, the organizational readiness webpages containing questions regarding a readiness of the healthcare provider to adopt the EHR system;
provide technology and workflow planning webpages to the healthcare provider, the technology and workflow planning webpages containing questions regarding how the healthcare provider intends to use the EHR system in workflows performed by the healthcare provider, the technology and workflow planning webpages containing questions regarding how the healthcare provider intends to implement the EHR system;
generate a EHR transition plan based on the responses, the EHR transition plan summarizing the readiness of the healthcare provider to adopt the EHR system, how the healthcare provider intends to use the EHR system in the workflows performed by the healthcare provider, and how the healthcare provider intends to implement the EHR system; and
provide the EHR transition plan to the healthcare provider.

16. The computing device of claim 15,
wherein the computer-executable instructions, when executed, further cause the computing device to provide a personnel planning webpage to the healthcare provider, the personnel planning webpage containing questions that prompt the healthcare provider to select people to participate in a process of transitioning the healthcare provider's practice to the EHR system; and
wherein the EHR transition plan lists the selected people.

17. The computing device of claim 12,
wherein the computer-executable instructions, when executed, further cause the computing device to receive device compatibility data from the healthcare provider in response to one of the questionnaires, wherein the device compatibility data identifies types of devices with which the EHR system is able to communicate; and
wherein the description of the EHR system includes the device compatibility data.

18. The computing device of claim 12,
wherein the computer-executable instructions, when executed, further cause the computing device to receive data that indicates a practice management strategy, the practice management strategy indicating how the EHR system integrates with practice management software; and
wherein the description of the EHR system includes the practice management strategy.

19. The computing device of claim 12, further comprising: wherein the computer-executable instructions, when executed, further cause the computing device to:
generate a cover letter for the RFP, the cover letter containing data based on the responses; and
send the RFP to the selected vendor.

20. A computer-readable storage medium that stores computer-executable instructions that, when executed by a computing device, cause the computing device to:
provide preparation webpages to a healthcare provider, the preparation webpages including questionnaires to be completed by the healthcare provider;
generate a request for proposal (RFP), the RFP requesting a proposal for providing an EHR system to the healthcare provider, the RFP containing a description of the EHR system, the server generating the description of the EHR system based on responses to the questionnaires, the responses received from the healthcare provider; and
generate a cover letter for the RFP, the cover letter containing data based on the responses
send the RFP and the cover letter to a selected vendor, the selected vendor identified by vendor selection input received from the healthcare provider
send a vendor portal webpage to the selected vendor, the vendor portal page containing a form that enables the selected vendor to send the proposal to the server
receive the proposal from the selected vendor in response to the RFP; and
provide the proposal to the healthcare provider
